(19) United States
(12) Patent Application Publication
(10) Pub. No.: US 2011/0008489 A1
(43) Pub. Date: Jan. 13, 2011

(54) QUALITY AND VALUE OF CO-PRODUCTS OF THE ETHANOL PRODUCTION INDUSTRY

(75) Inventors: Thomas W. Robb, Overland Park, KS (US); Praveen V. Vadlani, Manhattan, KS (US); Inaki Mielgo, Sevilla (ES); Ronald L. Madl, Manhattan, KS (US)

Correspondence Address: SENNIGER POWERS LLP, 100 NORTH BROADWAY, 17TH FLOOR, ST LOUIS, MO, 63102, US

(73) Assignee: ABENGOA BIOENERGY NEW TECHNOLOGIES, INC., Chesterfield, MO (US)

(21) Appl. No.: 12/747,992

(22) PCT Filed: Nov. 26, 2008
(86) PCT No.: PCT/US08/84814

§ 371 Date: Sep. 14, 2010

Related U.S. Application Data
(60) Provisional application No. 61/013,695, filed on Dec. 14, 2007.

(51) Int. Cl. A23K 1/14

(52) U.S. Cl. 426/18; 426/656; 426/601

(57) ABSTRACT

A process for improving the nutritional quality of a feed co-product, resulting from the fermentation of a grain, sugar beets, or sugar cane to produce ethanol. The process comprises combining water, a source of nitrogen, a source of phosphorus, a feed co-product comprising a cellulose and/or a hemi-cellulose, and a microbe to form a fluid fermentation mixture suitable for submerged fermentation, wherein the feed co-product is derived from the fermentation of a grain, sugar beet, or sugar cane to produce ethanol and wherein the microbe is a microbe capable of breaking down the cellulose and/or the hemi-cellulose to one or more sugars and then utilizing the sugars to proliferate; fermenting the fluid fermentation mixture such that the microbe converts at least a portion of the cellulose and/or the hemi-cellulose into at least one sugar and uses the sugar to proliferate thereby increasing the concentration of microbes in the fermentation mixture.

### FIELD OF THE INVENTION

The present invention relates to a method for improving the quality and value of feed co-products resulting from the process of fermenting starch from cereal grains to produce ethanol and to the value-added feed co-products produced by the method.

### BACKGROUND OF THE INVENTION

Ethanol produced from cereal grains yields co-products that are useful as animal feeds. These feeds are known in the art as Wet Distillers Grains (WDG), Dried Distillers Grains (DDG), Wet Distillers Grains Plus Solubles (WDGS) or Dried Distillers Grains plus Solubles (DDGS). Removal of the starch component during fermentation concentrates the original protein, mineral, vitamin, fiber, and fat content. For example, drymill ethanol production uses the starch portion of the corn, which is about 70% of the kernel. The starch component is converted by enzymatic hydrolysis to sugars which are then fermented to form ethanol. The ethanol is recovered by distillation. The remaining nutrients are concentrated into wet distillers grains (WDG) or Wet Distillers Grains Plus Solubles (WDGS). The WDG or WDGS may be used directly as a feed co-product or may be dried to form dried distillers grains (DDG). Drying increases its shelf life and improves its transportability.

These grain products, as well as condensed distillers solubles (CDS) and dried distillers solubles (DDS), have been used in dairy rations for over a century. Research conducted over the past 50 years comparing these products to other protein and energy feeds has proven their value. See Armentano 1994 & 1996; Nichols et al. 1998; Schingoethe et al., 1999; Liu et al., 2000 and Al-Suwaiegh et al., 2002. DDGS has become a common component of commercial dairy protein supplements, often comprising 25-35% of the blend on a dry matter basis depending upon the price of other competing ingredients. A common measurement that is often used by dairy nutritionists is that one pound of DDGS is roughly equivalent to 0.6 pounds of shelled corn and 0.4 pounds of soybean meal. See “Distillers in dairy: dollars meet demand” by Byron Moore, appearing in Feed Management, May/June 2007, pp. 18-19, quoting Robert Kaiser of University of Wisconsin-Extension.

Among the grain feed components, protein has the highest value commercially while fiber has the least value. Although the nutritional value of grain feed products may vary slightly according to its source (e.g. corn, sorghum (milo), sugar beets) and crop quality, these are essentially commodity products. Accordingly, a method for improving the quality and value (i.e., increased protein content and/or decreased fiber content) of grain feed co-products resulting from ethanol production is desirable to distinguish value-added grain feed products from the grain feed products currently available from the commodity markets.

### SUMMARY OF THE INVENTION

Briefly, therefore, the present invention is directed to process for improving the nutritional quality of a feed co-product, resulting from the fermentation of a grain, sugar beets or sugar cane to produce ethanol. The process comprises combining water, a source of nitrogen, a source of phosphorus, a feed co-product comprising a cellulose and/or a hemi-cellulose, and a microbe to form a fluid fermentation mixture suitable for submerged fermentation, wherein the feed co-product is derived from the fermentation of a grain, sugar beet or sugar cane to produce ethanol and wherein the microbe is a microbe capable of breaking down the cellulose and/or the hemi-cellulose to one or more sugars and then utilizing the sugars to proliferate; fermenting the fluid fermentation mixture such that the microbe converts at least a portion of the cellulose and/or the hemi-cellulose into at least one sugar and uses the sugar to proliferate thereby increasing the concentration of microbes in the fermentation mixture.

The present invention is further directed to process for producing a high protein feed mixture from a cereal grain. The process comprises combining water, an enzyme and a cereal grain comprising a carbohydrate to form a hydrolysis mixture wherein at least a portion of the carbohydrate is converted by enzymatic hydrolysis into one or more sugars to form a hydrolysate mixture; adding yeast to the hydrolysate mixture such that at least a portion of the sugar is converted by fermentation to ethanol to form a first fermentation mixture comprising ethanol, a cellulose and/or hemi-cellulose and water; distilling the first fermentation mixture to remove at least a portion of the ethanol from the first fermentation mixture thereby forming a distillate product comprising ethanol and a whole stillage fluid mixture comprising water, a cellulose and/or hemi-cellulose; adding a source of nitrogen, a source of phosphorus and a microbe to the whole stillage mixture to form a second fermentation mixture, wherein the microbe is a microbe capable of breaking down cellulose and/or hemi-cellulose to one or more sugars and then utilizing the sugars to proliferate; and fermenting the second fluid fermentation mixture during which the microbe breaks down at least a portion of the cellulose and/or hemi-cellulose in the second fermentation mixture to at least one sugar and uses the sugar to proliferate to form a high protein feed mixture, wherein a substantial portion of the protein in the high protein feed mixture is microbial protein.

The present invention is still further directed to a feed mixture resulting from the fermentation of a grain, sugar beets or sugar cane to produce ethanol. The feed mixture comprises a protein, at least a portion of which is in the form of a microbial protein, wherein the total concentration of protein present in the feed mixture is at least about 30 percent by weight of the feed mixture on a dry basis, and wherein the concentration of microbial protein in the feed mixture is at least about 10 percent by weight of the feed mixture, on a dry basis.

The present invention is still further directed to a feed product comprising grain carbohydrate, grain ash, grain oil, a nitrogen source selected from the group consisting of grain protein and amino acids, and a further nitrogen source comprising microbial protein, wherein the total protein content is at least about 30 wt. % on a dry basis.

Other objects and features will be in part apparent and in part pointed out hereinafter.

### BRIEF DESCRIPTION OF THE DRAWINGS

FIG. 1 is a flow chart depicting the process of the present invention.

Corresponding reference characters indicate corresponding parts throughout the drawings.

### DESCRIPTION OF THE PREFERRED EMBODIMENTS

The method of the present invention comprises exposing a feed co-product resulting of vegetable fermentation to one or more cellulolytic micro-organism(s) capable of utilizing the fiber component of the feed co-product as a substrate for growth and proliferation. The co-product used in the method may be obtained in the fermentation of grain, sugar beets, or sugar cane to produce ethanol. The cellulolytic micro-organisms referred to in the present invention are microbes possessing an enzyme or enzyme system that can break down the cellulose and/or hemi-cellulose to form simple sugar(s), i.e., capable of producing one or more cellulase, hemi-cellulase, or cellusome complex. The microbe then uses the simple sugar along with other nutrients such as nitrogen and/or phosphorus to grow and proliferate, thereby increasing the microbial protein content of the feed co-product.

The process of the present invention may be carried out, for example on a whole stillage co-product obtained after ethanol distillation but before further processing. The process of the present invention may also be carried out, for example, on subsequent process streams such as a WDG obtained from the centrifugation of the whole stillage or even on other co-products such as DDG, DDGS, and WDGS.

In general, the method of the present invention converts lower food quality fiber contained in feed co-products into a higher quality microbial protein while maintaining a portion or all of the protein that was obtained from the original cereal grain. In addition, the cellulolytic micro-organisms used in the process of the present invention typically reverse heat damaged protein, i.e., protein that has been thermally bound to a fiber, by consuming the fiber and freeing up the bound protein. Heat damaged protein is believed to be less soluble and therefore typically considered of lower nutritional quality than non-heat damaged protein.

Additionally, microbial protein is generally higher quality than plant protein. In general, microbial protein has an amino acid profile that more closely resembles an animal's metabolic amino acid requirement to produce proteins required for growth and maintenance. Moreover, microbial protein is more digestible and therefore more readily available to digest and absorb.

Products of the present invention thus possess protein values of 40% or more by weight of the feed mixture on a dry basis. The protein content typically comprises plant protein of about 25% by weight to 30% by weight of the feed mixture on a dry basis and microbial protein of at least about 10% by weight of the feed mixture on a dry basis. Typical commodity grain feed products have protein values based only on the plant protein.

Since the nutritionally enhanced feed co-products of the present invention have a greater nutritional quality than conventional feed co-products, such as conventional dried distillers grains, it is believed the product of the present invention will increase the commercial value of the feed co-product enhancing the effective productivity and ultimate profitability of the overall ethanol production process. The feed co-product of the present invention may be utilized as a high quality feed for all animal feed applications. For example, the product of the present invention may be utilized as a feed for ruminant (e.g., cattle, goats, sheep, bison, antelope, etc.) and mono-gastric animals (e.g., pigs) and may even be used for human consumption.

Ethanol and a corresponding feed co-product may be produced from a variety of feedstocks using any conventional dry mill or wet mill process known in the art. See for example, CORN, Chemistry and Technology, Stanley A. Watson and Paul E. Ramstad, editors, Published by the American Association of Cereal Chemists, Inc. St. Paul, Minn., USA, the entire contents of which are incorporated herein by reference. The feedstock used in the process of the present invention may be any feed stock comprising at least 50% by weight of a carbohydrate, such as a starch or sugar, including for example a grain, sugar cane or sugar beets. Typically the feed stock comprises corn, grain sorghum (milo), wheat, barley, oats, triticale, rice, millet, rye, buckwheat, sugar cane, sugar beet, or any combination or combinations thereof. More typically, the feedstock comprises corn, grain sorghum, wheat, sugarcane, and/or sugar beets. More typically, the feedstock comprises corn.

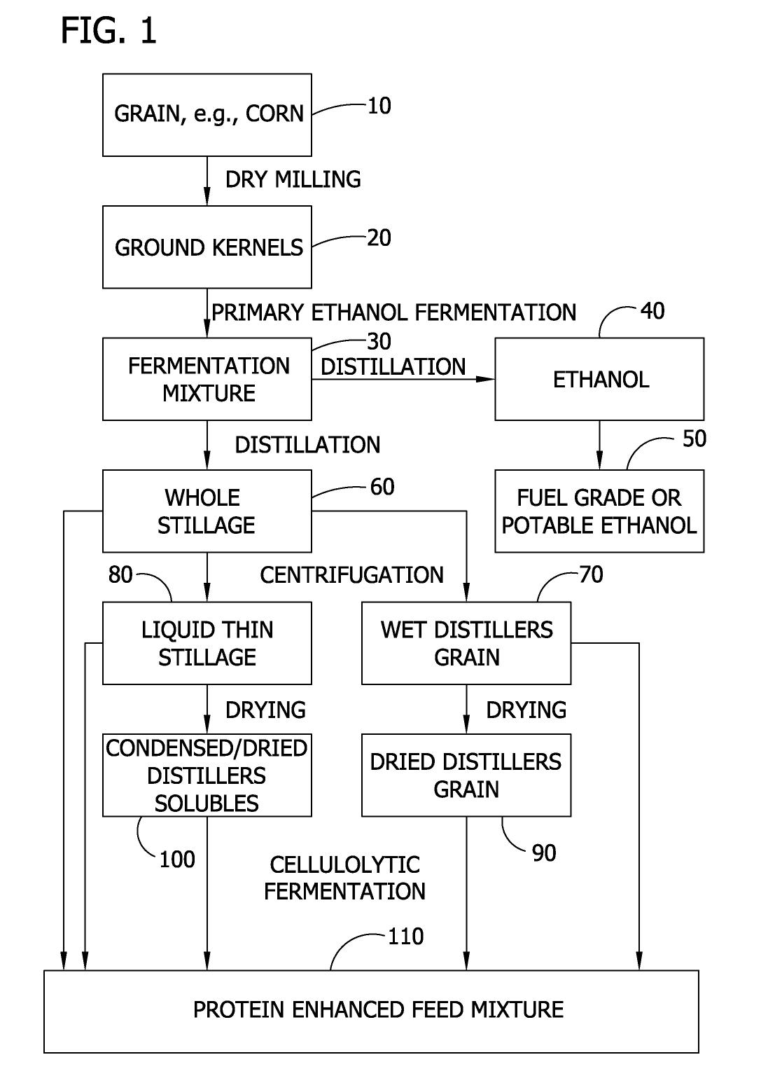

In an exemplary embodiment, with reference to FIG. 1, the process of the present invention uses a typical dry milling process known in the art for converting cereal grains to produce fuel ethanol and feed co-products such as WDG, DDG, SDGS, or DDGS. Cereal grains 10 such as corn, for example, are subjected to dry milling, which begins with grinding and cooking the kernels. The ground kernels 20 are then liquefied and treated with enzymes that saccharify (by enzymatic hydrolysis) the starch content of the kernels to convert at least a portion of the starch component(s) to one or more sugars, typically simple sugars. The hydrolyzed mixture is then fermented, during primary ethanol fermentation, in the presence of a yeast, which converts at least a portion of the sugar content into carbon dioxide and ethanol. The fermentation mixture 30, at this point, comprises ethanol and whole stillage. The whole stillage comprises protein, cellulose, hemi-cellulose, fibers, fat, and lignin. A conventional distillation process is used to remove at least a portion and preferably most or even all of the ethanol 40 present in the fermentation mixture. The ethanol 40 may then be further treated to dehydrate the ethanol distillate to produce fuel grade or potable ethanol 50. It should be noted in this regard that the removal and subsequent treatment of the ethanol is not required to perform the process of the present invention, however, for commercial reasons it is typically preferred to do so.

In one or more embodiments of the present invention, the whole stillage 60 remaining after the distillation process is completed may be directly subjected to a cellulolytic fermentation using a cellulolytic micro-organism to convert at least a portion of the cellulose or hemi-cellulose present in the whole stillage 60 to microbial protein. In other embodiment(s), the whole stillage 60 may be first processed by centrifugation, any other commercially acceptable separation methods, to separate the insoluble wet grains 70 (wet distillers grain) from the soluble materials that remain in the liquid thin stillage 80. According to the present invention, the wet distillers grain 70 and/or the thin stillage 80 may be subjected to a fermentation using a cellulolytic micro-organism to convert at least a portion of the cellulose or hemi-cellulose to microbial protein. In yet another embodiment of the present invention, the wet distillers grains 70 may be dried yielding dried distillers grain 90. The thin stillage 80 may be evaporated, yielding condensed distillers solubles or dried distillers solubles 100. These may be combined, yielding dried distillers grains with solubles which may then be subjected to a fermentation using a cellulolytic micro-organism to convert at least a portion of the cellulose or hemi-cellulose to microbial protein.

It should be noted in this regard that any of the above mentioned product streams derived from the whole stillage, including the whole stillage itself, may be subjected to a fermentation using one or more cellulolytic micro-organism(s) to convert at least a portion or all of the cellulose or hemi-cellulose to microbial protein without departing from the scope of the present invention, and thereby yield a protein enhanced feed mixture 110. Moreover, each of the process streams subjected to a fermentation using one or more cellulolytic micro-organism(s) may be exposed to the same cellulolytic micro-organism or mixture of cellulolytic micro-organisms or alternatively, the process streams may be subjected to differing cellulolytic micro-organisms or different mixtures of cellulolytic micro-organisms. Moreover, various streams may be subjected to such a fermentation to increase the microbial protein content and form a protein enhanced feed co-product 110 and may also be recombined to form an protein enhanced feed co-product 110 without departing from the scope of the present invention.

The following discussion will describe in more detail an embodiment wherein the whole stillage is subjected to the process of the present invention. It should be noted in this regard, that while the following description of the process of the present invention is in the context of the whole stillage stream, it in no way is limited to this particular process stream, but may equally be applied to the various other process streams as discussed above.

In certain embodiments of the process of the present invention, the whole stillage (the co-product from the distillation) is subjected to a cellulolytic fermentation wherein the cellulose and/or hemi-cellulose component of the whole stillage serves as a growth medium for microbial growth. That is, the whole stillage contains, among other components, cellulose and/or hemi-cellulose and may also contain protein including protein heat-damaged by maillard browning, and/or one or more lignin(s). The cellulitc microbes saccharify the cellulose and/or the hemi-cellulose to simple sugars. Without being bound to a particular theory, it is believed that the cellulolytic micro-organisms used in the present invention are microbes which produce cellulase, hemi-cellulase and cellusome complexes capable of breaking down the cellulose and/or hemi-cellulose components into simple sugars which are then combined with nitrogen to produce amino acids. The amino acids are then combined into microbial proteins. By converting sugars and nitrogen into microbial protein, the microbes proliferate and increase the proportion of overall protein in the feed co-product, primarily by increasing the proportion of microbial protein in the feed co-product.

Since microbial proliferation depends, in part, upon protein synthesis, the cellulolytic fermentation whole stillage growth medium comprises a source of nitrogen as discussed in more detail below. In addition, the whole stillage growth medium further comprises water sufficient to form a fluidized mixture. In addition, the fermentation mixture may contain a number of other nutrients such as phosphorus and oxygen, which are utilized by the microbes to grow and proliferate. The whole stillage growth medium may comprise other nutrients to further optimize growth conditions, depending upon the particular microbe used.

According to the present invention, the cellulolytic fermentation mixture is fluidized or at least sufficiently mixed to allow the cellulolytic micro-organisms and/or the nutrients sufficient transport to bring the cellulolytic micro-organism into contact with the sugar and other nutrients thereby allowing for microbial proliferations.

The fermentation of the fluid fermentation mixture may occur at any temperature at which the microbes are capable of surviving and proliferating. For example, the fermentation may be carried out at or slightly below ambient temperatures or may be carried out at elevated temperatures depending on the particular microbe used. The cellulolytic micro-organisms of the present invention typically fall into to categories, mesophiles and thermophiles. Mesophiles are microbes that generally grow best in moderate temperature ranges, for example, between about 25° C. and about 45° C. Thermophile microbes prefer warmer temperatures (45 to 60° C.), for example, temperatures of at least about 45° C.

In addition, the cellulolytic fermentation of the present invention may be carried out as a submerged fermentation. In submerged fermentation, free water is abundant and comprises a significant fraction of the growth medium, such that the culture medium is free flowing. Submerged fermentation allows for the use of different water soluble sources of nutrients and, since it is often accompanied by agitation, allows for the uniform distribution of the microbes throughout the culture medium. The cellulolytic micro-organisms may be either aerobic or anaerobic microbes.

In general, any microbe that produces cellulase enzymes, hemi-cellulase enzymes, or cellulosome complexes of such enzymes may be used in the process of the present invention. Preferably, the microbes used in the process of the present invention produce more than one of cellulase enzymes, hemi-cellulase enzymes, and cellulosome complexes of such enzymes. In general, the microbes may be divided into four classes: aerobic bacteria, anaerobic bacteria, yeast, and fungi. In some embodiments, microbes from more than one of the classes may be added to the fermentation mixture.

According to the present invention, a process stream is subjected to a secondary fermentation using one or more cellulolytic micro-organisms. In some embodiments, the process stream may be subjected to multiple fermentations with each fermentation using a different cellulolytic micro-organism or mixture of cellulolytic micro-organisms. When multiple fermentation processes are employed, they may be conducted in series or in parallel and fermentation products maintained as separate products or recombined. In this regard, multiple cellulolytic micro-organisms, which may utlize the same or similar nutrients may be used. For example, a portion of a process stream may be subjected to one or more anaerobic microbes and another portion subjected to aerobic microbes.

Applicable aerobic bacteria include species selected from the genera Cellulomonas, Bacillus, Thermobifida, Thermoactinomyces, Cytophaga, and Sporocytophaga.

Cellulomonas are mesophilic, cellulose-degrading, aerobic bacteria. Cellulomonas species that may be used in the method of the present invention include Cellulomonas sp (ATCC 21399) and Cellulomonas fimi.

Bacillus is a genus of rod-shaped, Gram-positive bacteria belonging to the Firmicutes. Bacillus species that may be used in the method of the present invention include Bacillus subtilis, Bacillus amyloliquefaciens, Bacillus amerellis, and Bacillus licheniformis. B. subtilis is known to degrade pectin and polysaccharides in plant tissues.

Thermobifida species that may be used in the method of the present invention include Thermobifida fusca. Thermobifida fusca is a thermophilic soil bacterium (growth temperature 55° C.) that degrades plant cell walls in heated organic materials. It possesses extracellular enzymes, including cellulases that have thermostability, broad pH range (4-10), and high activity. It appears to degrade all major plant cell wall polymers except lignin and pectin and can grow on most simple sugars and carboxylic acids.

Thermoactinomyces is a genus of bacteria of the family Micromonosporaceae, consisting of thermophilic (45° C. to 60° C.) organisms. Thermoactinomyces species that may be used in the method of the present invention include Thermoactinomyces sacchari, Thermoactinomyces vulgaris, and Thermoactinomyces candidus.

Cytophaga is a genus of gram-negative rod-shaped bacteria that are aerobic or facultatively anaerobic. Cytophaga species are known to degrade plant material, especially polymers such as cellulose. Cytophaga species that may be used in the method of the present invention include C. johnsonae.

The Sporocytophaga is a genus of aerobic bacteria that are known to digest cellulose and other components of cell walls, but not ligno-cellulose. A thermophilic strain grows at 55° C. to 65° C. An applicable species for the method of the present invention is S. myxococcoides.

Applicable anaerobic bacteria include species selected from the genera Clostridium, Ruminococcus, Caldicellulosiruptor, Erwinia, Bacteroide, Lachnospira, Butyrivibrio, and Peptostreptococcus.

Clostridium is a large genus of bacteria belonging to the Firmicutes. Clostridium species that may be used in the method of the present invention include Clostridium cellulovorans and Clostridium thermocellum. Growth substrates for C. cellulovorans include cellulose, xylan, pectin, cellobiose, glucose, maltose, galactose, sucrose, lactose, and mannose. C. thermocellum is capable of producing ethanol directly from cellulose due to large extracellular cellulase system called the cellulosome.

Ruminococcus describes a genus of anaerobic bacteria that inhabit the rumen of cattle, sheep, and goats. Species of this genus allow their hosts to digest cellulose. Ruminococcus species that are applicable to the method of the present invention include Ruminococcus flavefaciens and Ruminococcus albus.

Caldicellulosiruptor is a genus of thermophilic (70° C.), anaerobic, asporogenous bacterium. An applicable species is C. saccharolyticus, which is known to hydrolyze a variety of polymeric carbohydrates (cellulose, hemi-cellulose, pectin, α-glucan (starch, glycogen), β-glucan (lichenan, laminarin), and guar gum) to acetate, lactate, hydrogen, and carbon dioxide.

Erwinia is a genus of facultative anaerobic bacterium. An applicable species is Erwinia chrysanthemis, which is known source of cellulase enzyme.

Bacteroide is a genus of gram-negative, non-endospore forming anaerobes. Bacteroides are aero-tolerant and are known to break down polysaccharides and simple sugars. Applicable species include B. succinogenes and Bacteroides ruminicola.

Butyrivibrio is a genus of xylanolytic bacterium commonly found in ruminants. They are known to degrade and utilize various xylans. An applicable species is Butyrivibrio fibrisolvens.

Lachnospira is a genus of anaerobic Pectin and polysaccharide degrading bacteria. An applicable species is Lachnospira multiparus.

Peptostreptococcus is a genus of anaerobic, Gram-positive, non-spore forming bacteria. The cells are small, spherical, and can occur in short chains, in pairs or individually.

Applicable yeast includes species selected from the genera Candida, Zymononas, Saccharomyces, Pachysolen, and Yamadazyma. Candida species that may be used in the method of the present invention include Candida cugosa. Zymononas species that may be used in the method of the present invention include Zymomonas mobilis. Saccharomyces is a genus of fungus known to be useful in the production of food and alcoholic beverages. Pachysolen species that may be used in the method of the present invention include Pachysolen tannophilus. P. tannophilus is known to convert glucose and xylose to ethanol. Yamadazyma species include Yamadazyma stipitis.

Applicable fungi include species selected from the phyla Chytridiomycetes, Ascomycetes, Basidiomycetes, and Deuteromycetes. Applicable genera within the Chytridiomycetes phylum include Neocallimastix, Piromonas, Piromyces, Caecomyces Oripmomyces, and Anaeromyces. Applicable genera within the Ascomycetes phylum include Aspergillus, Trichoderma, Penicillum, Fusarium, Geotrichum, Bulgaria, Chaetomium, Paecilomyces, Helotium, Humicola, Sclerotinia, and Myceliopthora. Applicable genera within the Basidiomycetes phylum include Coriolus, Phanerochaete, Poria, Postia, Schizophyllum, Serpula, and Gloeophyllum. Applicable genera within the Deuteromycetes phylum include Cladosporium and Myrothecium.

Aspergilli are filamentous, highly aerobic fungi that can be found in almost all oxygen-rich environments, where they commonly grow as molds on the surface of a substrate. Aspergillus species that may be used in the method of the present invention include Aspergillus oryzae, Aspergillus niger, and Aspergillus aculeatus. A. oryzae is known to saccharify rice, potatoes, and grains for fermentation in the making for sake, for example.

Trichoderma species are known to produce extracellular enzymes, including cellulases and other enzymes that degrade complex polysaccharides. Trichoderma species that may be used in the method of the present invention include Trichoderma reesei. T. reesei has a long history of safe use in industrial-scale enzyme production, including cellulases and xylanases.

Additional applicable fungi include Neocallimastix frontalis, Postia placenta, Gloeophyllum trabeum, Sclerotinia cinerea, Fusarium oxysporum, Humicola insolens, Humicola lanuginosa, Microbispora bispora, Myceliopthora thermophile, and Piromonas communis.

These fungi are known to produce various enzymes for degrading polysaccharides, including cellulases, hemi-cellulases, and xylanases. For example, Neocallimastix frontalis is a ruminal anaerobic fungus known to produce xylanase and cellulase. Postia placenta is a thermotolerant decay fungi. Gloeophyllum trabeum grows on the surface of dead trees in temperate North American forests and has a preference for hardwoods. Both Gloeophyllum trabeum and Postia placenta are characterized as brown-rot fungi because of the manner in which they degrade wood lignocellulose. Brown-rots depolymerize the cellulosic and hemicellulosic components of this substrate and leave the pigmented lignin biopolymers oxidized but intact. Myceliopthora thermophile grows optimally between 35-48° C., but it may be cultured in temperatures ranging from 25-55° C. and will tolerate brief exposure to temperatures as high as 59° C. This thermophilic fungus is frequently isolated from the soil and from self-heating masses of composted vegetable matter where it contributes to the decomposition of structural plant polysaccharides. M. thermophila is proficient at degrading wood and other cellulosic substances.

To optimize growth conditions, the vessel containing the whole stillage growth medium further comprises a source of nitrogen, a source of phosphorus, and water. When using aerobic microbes, a source of oxygen is added to the whole stillage growth medium.

Water may be added to the vessel comprising the whole stillage growth medium to yield a fluid fermentation mixture suitable for submerged or deep vat fermentation. Fluid, submerged fermentation, as opposed to solid state fermentation, is advantageous for many reasons. Among them, fluid fermentation allows for better control of such factors as pH, temperature, oxygen and nitrogen diffusion, and better distribution of gas and other nutrients throughout the fluid fermentation mixture. These advantages may be achieved with agitation and/or bulk mechanical mixing, which enhances flow of fresh nutrition to the microbes, as opposed to solid state fermentation, wherein nutrition to the microbe is diffusion-based and may causes the microbe to “starve.” Microbial starvation in this manner promotes enzyme formation at the expense of microbial proliferation. In contrast, submerged, deep vat fermentation with mechanical mixing promotes microbial “feeding,” which promotes microbial growth and proliferation. In this regard, the amount of water in the fermentation mixture is preferably sufficient to provide a fluidized mixture having a continuous or semi-continuous liquid phase capable of providing sufficient transport of nutrients to the microbes such that microbial proliferation occurs preferentially to enzyme production.

The water content may be carried forward from previous process steps in part or in whole or may be added to the fermentation mixture prior to the cellulolytic fermentation of the mixture. The concentration of water in the fluid fermentation mixture is typically at least about 65% by weight of the total contents of the mixture, more typically between about 65% by weight and about 95% by weight. In some embodiments, the concentration of water in the fermentation mixture may be between about 68% by weight and about 90% by weight of the total contents of the mixture or even between about 70% by weight and about 80% by weight of the total contents of the mixture. The significant water fraction yields a relatively low viscosity growth medium which provides an advantage in lowering the mixing power requirements.

Similarly, the nitrogen content may be carried forward from previous process steps in part or in whole or may be added to the fermentation mixture prior to the cellulolytic fermentation of the mixture. Typically, a nitrogen source is added to the fluid fermentation mixture. Exemplary sources of nitrogen include ammonia, urea, ammonia sulfate, and elemental nitrogen, however any other nitrogen source capable of providing the cellulolytic micro-organism with a nitrogen nutrient may be used. Typically, the nitrogen source is ammonia, urea and/or ammonia sulfate, ammonium chloride, ammonium phosphate which may be conveniently added to the fluid fermentation mixture. The source of nitrogen added to the fluid fermentation mixture may be added in an initial amount sufficient to yield a concentration of nitrogen between about 1% by weight and about 10% by weight of the total contents of the mixture, or between about 2% by weight and about 8% by weight. Typically, the concentration of nitrogen added to the fluid fermentation mixture is between about 2% by weight and about 7% by weight. In some embodiments, the pH may be controlled by adding the source of nitrogen, e.g., aqueous ammonia, throughout cellulolytic fermentation. It should be noted, however, that the precise nitrogen concentration added may vary, without departing from the scope of the present invention, depending on the amount of nitrogen nutrient required by the cellulolytic micro-organism or mixture of cellulolytic micro-organisms and the amount of nitrogen initially within the mixure. It should also be noted that the nitrogen may be added at the beginning of the fermentation or may be added either continuously or periodically throughout the fermentation provided a sufficient amount of nitrogen is available to the cellulolytic micro-organism for proliferation.

Phosphorus is a component of the phosphate moiety in nucleic acids. As such, phosphorus may also be supplied as a nutrient. The phosphorus content may be carried forward from previous process steps in part or in whole or may be added to the fermentation mixture prior to the cellulolytic fermentation of the mixture. In embodiments utilizing phosphorus as a nutrient, the phosphorus is typically added to the fermentation mixture. Exemplary sources of phosphorus include phosphoric acid and phosphate salts, such as potassium phosphate, sodium hydrogen phosphate salts and potassium hydrogen phosphate salts. Typically the phosphorus source is potassium phosphate. The source of phosphorus may be added to the fluid fermentation mixture in a concentration between about 0.05% by weight and about 2% by weight of the total contents of the mixture and is typically between about 0.3% by weight and about 0.8% by weight, or event between about 0.01% by weight and about 1% by weight. It should be noted, however, that the precise concentration of phosphorus added may vary, without departing from the scope of the present invention, depending on the amount of phosphorus nutrient required by the cellulolytic micro-organism or mixture of cellulolytic micro-organisms and the amount of phosphorus initially within the mixture. It should also be noted that the phosphorus may be added at the beginning of the fermentation or may be added either continuously or periodically throughout the fermentation provided a sufficient amount of phosphorus is available to the cellulolytic micro-organism for proliferation.

When an aerobic microbe is used, the fluid fermentation mixture preferably comprises oxygen. The oxygen may be carried forward from previous process step, i.e., dissolved oxygen, or may be added to the fermentation mixture prior to and/or while carrying out the cellulolytic fermentation. Exemplary sources of oxygen include atmospheric air or elemental oxygen. Typically the oxygen source is atmospheric air, which may be introduced in the form of a gas and bubbled through the fluid fermentation mixture to allow oxygen to be incorporated into the mixture. The rate at which oxygen is bubbled or flowed into the fluid fermentation mixture is generally sufficient to maintain an oxygen concentration (of dissolved and dispersed oxygen) in the mixture of between about 10 mg/L and about 80 mg/L and typically between about 10 mg/L and about 60 mg/L or more typically between about 10 mg/L and about 40 mg/L during the fermentation of the fluid fermentation mixture.

Additional nutrients may be added if desired without departing from the scope of the present invention. It should be noted, however, that because the substrate being treated is a product of a yeast fermentation, many of these nutrients may already be present in varying amounts.

As stated above, the method of the invention preferably involves submerged fermentation in a fluid fermentation mixture. Such a method confers the ability to control the mixture pH. The pH is preferably maintained within a range within which the cellulolytic micro-organisms achieve the highest proliferation rates, that is, the pH is controlled and maintained during fermentation of the fluid fermentation mixture at or near the rate determined to be optimal for the individual microbe being utilized. The pH of the mixture may vary widely, such as from about 2.5 to about 10.0. In some embodiments, the pH is maintained near neutral, such as between about 4.0 and about 9.0, more typically between about 6.0 and about 8.0, however depending on the cellulolytic micro-organism the pH may be maintained on the acidic side or basic side. Any acid or base may be added to control the pH within the desired range during fermentation. Exemplary acids include sulfuric acid, citric acid, hydrochloric acid and phosphoric acid and exemplary bases include ammonia, e.g., aqueous ammonia, and sodium hydroxide. Additionally, the acids and/or bases selected may be chosen to provide additional nutrients such as nitrogen and/or phosphorus.

To prepare the cellulolytic micro-organism for inoculation, the selected organism may be grown in any appropriate growth medium, such as, for example, on agar plates (Difco Nutrient Broth, Spectrum Chemicals, Gardena, Calif.). After growth, the organisms are transferred, using sterile transfer techniques, from the agar plates into a liquid broth medium, such as Difco Nutrient liquid broth media, contained in flasks (with sterile wire loops) which are then stoppered with sterile cotton. Typically, the flasks are maintained in a controlled temperature shaker water bath to provide for agitation and aeration. The flasks are allowed to ferment for a period of time to allow adequate cellular proliferation.

According to the fermentation method of the present invention, whole stillage growth medium is combined with additional sources of nitrogen and phosphorus. The mixture may be thoroughly mixed using an appropriate method, such as agitation, stirring, or another method. The pH and temperature may be then adjusted to optimize microbial growth. For example, when Bacillus amyloliquifaciens is the microorganism, the desired temperature is between 35° C. to 45° C. and the optimal pH is around 7.0. Appropriate pH and temperature to achieve optimal microbial growth for other organisms may be determined with reference the scientific literature. This mixture is inoculated with an appropriate amount of culture, typically at a volumetric proportion equal to around 10%. The mixture is allowed to ferment for a sufficient period of time to maximize microbial cell proliferation. The length of fermentation may be at least about 2 hours, but is preferably longer, such as at least about 4 hours, at least about 6 hours, at least about 8 hours or even at least about 10 hours. In some embodiments, the length of the fermentation may be at least a day, several days, at least 6 days or even as long as 10 days or more. The optimum fermentation duration may depend upon the growth rate of the particular micro-organism, the desired total increase in microbial protein, and the marginal rate of increase in protein content after a certain fermentation duration.

For aerobic microbes, a source of oxygen is also added during fermentation, usually by adding compressed, sterile filtered air to the bottom of the fermentation vessel through a diffuser device which bubbles air into the bottom of the vessel. After the fermentation period, the entire mixture may be dried. Drying typically increases the dry matter to around 90% by weight.

During fermentation of the fluid fermentation mixture, the mixture temperature may be controlled to optimize growth conditions depending upon the microbe chosen. The mixture temperature may be at least about 20° C., typically between about 20° C. and about 55° C., more typically between about 25° C. and about 50° C. In some embodiments, the temperature of the mixture is controlled within a range of from about 30° C. to about 40° C. As has been stated, earlier, thermophilic organisms prefer higher temperatures while mesophilic organisms grow better at cooler temperatures.

As stated above, in submerged or deep vat fermentation, the mixture may be agitated, such as by mechanical mixing either by impeller mixing in the vessel or by recirculating the mixture with appropriate pumping. The size and rotation speed of the impeller in mechanical mixing or recirculating via pumps depends in part on fermentation conditions, such as volume of the fermentation vat and amount of fluid fermentation mixture. Agitation, however, should be sufficient to allow flow of fresh nutrition to the microbes to enhance the growth and proliferation of the microbes in the fermentation mixture, rather than merely enhancing their enzyme production.

The process of the present invention produces an improved feed co-product having an enhanced protein content and a reduced fiber content compared to prior methods. For example, cellulose (C-6 fiber components) and hemi-cellulose (C-5 fiber components) are generally consumed by the cellulolytic micro-organisms, thereby reducing the quantity of these fiber components in the feed co-product. Advantageously, sugars generated by hydrolysis of the fiber components are processed together with added nitrogen to produce microbial protein, thereby increasing the protein content of the feed co-product. Moreover, it has been discovered that the process of the present invention may additionally reverse heat damage to protein (such as by Maillard browning, for example). Heat damaged protein is largely unavailable to animal digestion. Finally, the quality of protein, as measured by solubility, is increased by the process of the present invention. Protein quality may be measured by degree of solubility since highly soluble protein is more available to the animal.

A feed co-product produced by the process of the present invention may comprise grain carbohydrate, grain ash, grain oil, a nitrogen source comprising proteins and amino acids originated from the grain, and a further nitrogen source comprising protein originating from the microbial proliferation, wherein the total protein content is at least about 30 wt. % on a dry basis. Typically, the total amount of protein is at least about 35% by weight of the feed mixture on a dry basis, preferably at least about 40% by weight of the feed mixture on a dry basis or even at least about 50% by weight of the feed mixture on a dry basis. In some embodiments, the total amount of protein is at least about 60% by weight or more of the feed mixture on a dry basis. At least about 10% by weight of the feed mixture on a dry basis is microbial protein, more typically, the microbial protein constitutes at least about 20% by weight of the feed mixture on a dry basis, preferably at least about 30% by weight of the feed mixture on a dry basis and may even be as much as at least about 40% by weight or more of the feed mixture on a dry basis. The plant protein content is typically at least about 20% by weight of the feed mixture on a dry basis, more typically between about 20% by weight of the feed mixture on a dry basis and about 40% by weight of the feed mixture on a dry basis.

As stated herein, the process of the present invention also reduces the amount of protein bound to a fiber (i.e., protein damaged by maillard browning). The total amount of protein bound to a fiber in the feed mixture produced by the process of the present invention is typically less than about 5% by weight of the feed mixture, more typically less than about 4% by weight of the feed mixture, even more typically less than about 3% by weight of the feed mixture.

The process of the present invention also increases the amount of soluble protein in the feed mixture. In general, the amount of soluble protein in the feed mixture of the present invention is typically at least about 20% by weight of the feed mixture, more typically at least about 25% by weight of the feed mixture, and even more typically at least about 35% by weight of the feed mixture.

The process of the present invention also reduces the amount of non-nutritive lignin in the feed mixture. Accordingly, the total amount of lignin present in the feed mixture is typically less than about 5% by weight of the feed mixture, more typically less than about 3% by weight of the feed mixture, and even more typically less than about 2% by weight of the feed mixture.

Having described the invention in detail, it will be apparent that modifications and variations are possible without departing from the scope of the invention defined in the appended claims.

### Examples

The following non-limiting examples further illustrate the present invention.

### Example 1

### Celluloytic Micro-Organism Screening

Whole stillage batches were fermented in the presence of a variety of cellulolytic micro-organisms in a screening experiment. The whole stillage (solids content of 30% by weight) was a feed co-product of ethanol production from corn. The micro-organisms screened included Aspergillus oryzae, Bacillus amyloliquefaciens, Yamadazyma stipitis, Pachysolen tannophilus, and F1 and F4 wild fungal strains. The cellulolytic micro-organisms were obtained from ATCC® (Manassas, Va.) and further cultured before fermentation (at facilities at Kansas State University, Manhattan Kans.).

For fermentation, whole stillage (100 g) and a cellulolytic micro-organism were combined in an Erlenmeyer shaker flask (250 mL). Ammonium sulfate (5.43 grams) and dibasic potassium phosphate (0.4 gram) were added to the flask as a nitrogen source and a phosphorus source, respectively. For aerobic cellulolytic micro-organism, aeration was accomplished by utilizing a shaker water bath to promote surface oxygen diffusion into the solution using an Innova 4000 Incubator Shaker (New Brunswick Scientific Co., Inc., Edison, N.J.).

Fermentation occurred for five days. Samples were taken after five days to measure the increase in crude protein and decrease in the fiber components. The results of the fermentation are shown in Table 1.

The cellulolytic micro-organisms exhibited wide variation with regard to increasing the crude protein mass in comparison to the control (no fermentation) and decreasing the cellulose/hemi-cellulose and lignin mass. In the screening experiment, nutrients were not added during the course of the fermentation. Without being bound to a particular theory, it is believed that certain cellulolytic micro-organisms may have initially caused a substantial increase in microbial protein. However, in view of the fact that nutrients were not added during the fermentation, the microorganisms may have become starved of nutrition and began to feed on protein, thereby reducing the total protein content in the fermentation mixture. This phenomena was observed in example 2 wherein the protein initially rose in several examples and began to decrease after 2 days. Other cellulolytic micro-organisms, on the other hand, had sufficient nutrition to proliferate and thereby increase the crude protein content and decrease the cellulose/hemi-cellulose and lignin mass.

TABLE 1
Celluloytic Micro-organism Screening

| | DM | Crude Protein | Hemicellulose | Cellulose | Lignin | | | | |
|---|---|---|---|---|---|---|---|---|---|
| | weight | weight | weight | weight | weight | % Crude | % Hemi- | | |
| Organism | (grams) | (grams) | (grams) | (grams) | (grams) | Protein | cellulose | % Cellulose | % Lignin |
| Control | 20.7 | 5.13 | 7.78 | 3.87 | 1.08 | 24.8 | 37.6 | 18.7 | 5.2 |
| F1 26 | 19.5 | 5.55 | 8.15 | 3.80 | 1.01 | 28.5 | 41.8 | 19.5 | 5.2 |
| F1 27 | 19.3 | 5.52 | 8.36 | 4.61 | 1.00 | 28.6 | 43.3 | 23.9 | 5.2 |
| US-TR + P. tan 26 | 19.4 | 5.48 | 8.57 | 4.54 | 1.03 | 28.2 | 44.2 | 23.4 | 5.3 |
| Y. stip 27 | 20.2 | 5.20 | 8.59 | 3.84 | 1.13 | 25.7 | 42.5 | 19.0 | 5.6 |
| F1 + Y. stip 27 | 19.2 | 5.27 | 8.12 | 3.72 | .75 | 27.5 | 42.3 | 19.4 | 3.9 |
| Control | 20.7 | 5.12 | 7.91 | 3.54 | 1.04 | 24.7 | 38.2 | 17.1 | 5.0 |
| TR 26 | 20.2 | 5.72 | 8.34 | 3.70 | 0.81 | 28.3 | 41.3 | 18.3 | 4.0 |
| TR 27 | 20.2 | 6.03 | 8.75 | 4.04 | 1.33 | 29.8 | 43.3 | 20.0 | 6.6 |
| P. tan + F1 26 | 18.6 | 5.09 | 8.28 | 3.63 | 1.15 | 27.4 | 44.5 | 19.5 | 6.2 |
| P. tan 26 | 20.1 | 5.43 | 8.78 | 4.00 | 1.95 | 27 | 43.7 | 19.9 | 9.7 |
| P. tan 27 | 20.3 | 5.70 | 8.57 | 3.88 | 0.89 | 28.1 | 42.2 | 19.1 | 4.4 |
| Y. stip 26 | 20.3 | 5.80 | 8.97 | 4.43 | 1.77 | 28.6 | 44.2 | 21.8 | 8.7 |
| Control | 23.7 | 6.01 | 10.76 | 5.52 | 2.01 | 25.3 | 45.4 | 23.3 | 8.5 |
| A.O. 1 | 17.7 | 6.52 | 5.59 | 2.90 | 0.39 | 36.9 | 31.6 | 16.4 | 2.2 |
| A.O. 2 | 18.9 | 6.27 | 6.96 | 3.10 | 1.15 | 33.1 | 36.8 | 16.4 | 6.1 |
| A.O. + Y. stip 1 | 19.8 | 6.47 | 7.21 | 4.65 | 0.87 | 32.7 | 36.4 | 23.5 | 4.4 |
| A.O. + Y. stip 2 | 20.3 | 6.76 | 7.98 | 4.57 | 1.24 | 33.3 | 39.3 | 22.5 | 6.1 |
| Y. stip 1 | 21.2 | 5.15 | 10.88 | 4.62 | 1.82 | 24.3 | 51.3 | 21.8 | 8.6 |
| Y. stip 2 | 21.4 | 5.48 | 10.19 | 4.92 | 1.03 | 25.6 | 47.6 | 230 | 4.8 |
| Y. stip + F4-1 | 21.7 | 6.04 | 9.57 | 5.77 | 1.91 | 27.8 | 44.1 | 26.6 | 8.8 |
| Y. stip + F4-2 | 20.9 | 5.37 | 9.11 | 4.56 | 2.30 | 25.7 | 43.6 | 21.8 | 11.0 |
| F4-1 | 22.1 | 6.83 | 10.74 | 4.82 | 1.68 | 30.9 | 48.6 | 21.8 | 7.6 |
| F4-2 | 22.6 | 6.88 | 9.61 | 4.54 | 2.08 | 30.4 | 42.5 | 20.1 | 9.2 |
| Control | 24.6 | 6.93 | 11.83 | 5.61 | 0.89 | 28.2 | 48.1 | 22.8 | 3.6 |
| P. tan | 23.5 | 7.49 | 12.10 | 5.97 | 1.20 | 31.9 | 51.3 | 25.4 | 5.1 |
| A.O. | 21 | 9.13 | 7.60 | 4.35 | 0.92 | 43.5 | 36.2 | 20.7 | 4.4 |
| A.O. + P. tan 1 | 21.7 | 8.97 | 7.81 | 4.01 | 1.45 | 41.3 | 36.0 | 18.5 | 6.7 |
| A.O. + P. tan 2 | 20.9 | 9.86 | 7.17 | 3.80 | 0.59 | 47.2 | 34.3 | 18.2 | 2.8 |
| F4 | 24.1 | 7.96 | 11.98 | 6.53 | 1.21 | 33.0 | 49.7 | 27.1 | 5.0 |
| F4 + A.O. 2 | 20.6 | 9.51 | 7.05 | 3.58 | 0.87 | 46.2 | 34.2 | 17.4 | 4.2 |
| F4 + P. tan 1 | 23.7 | 7.21 | 10.33 | 5.85 | 1.11 | 30.4 | 43.6 | 24.7 | 4.7 |
| F4 + P. tan 2 | 23.3 | 7.10 | 11.11 | 5.69 | 0.72 | 30.5 | 47.7 | 24.4 | 3.1 |

### Example 2

### Fermentation with Aspergillus oryzae

Whole stillage was fermented in the presence of Aspergillus oryzae. The whole stillage (solids content of 30% by weight) was a feed co-product of ethanol production from corn. A. oryzae was obtained from ATCC® (Manassas, Va.) and further cultured before fermentation (at facilities at Kansas State University, Manhattan Kans.).

For fermentation, whole stillage (100 g) and A. oryzae were combined in an Erlenmeyer shaker flask (250 mL). Ammonium sulfate (5.43 grams) and dibasic potassium phosphate (0.4 gram) were added to the flask as a nitrogen source and a phosphorus source, respectively. Since A. Oryzae is an aerobic fungus, aeration was accomplished by utilizing a shaker water bath to promote surface oxygen diffusion into the solution using an Innova 4000 Incubator Shaker (New Brunswick Scientific Co., Inc., Edison, N.J.).

Fermentation occurred for three days. Samples were taken to measure the increase in crude protein and decrease in the fiber components. The results of the fermentation are shown in Table 2.

TABLE 2
Fermentation in the Presence of A. oryzae

| | Control, Day 0 | Day 1 | Day 2 | Day 3 |
|---|---|---|---|---|
| Dry Matter weight | 21.6 | 19.8 | 18.9 | 18.3 |
| (grams) | | | | |
| Crude Protein | 5.4 | 7.3 | 8.5 | 8.8 |
| weight (grams) | | | | |
| Hemi-cellulose | 9.2 | 9.1 | 8.3 | 6.9 |
| weight (grams) | | | | |
| Cellulose weight | 4.1 | 4.0 | 3.7 | 4.1 |
| (grams) | | | | |
| Lignin weight | 1.1 | 0.8 | 0.7 | 0.7 |
| (grams) | | | | |
| % Crude Protein | 25.2 | 36.8 | 44.9 | 48.3 |
| % Hemi-cellulose | 42.7 | 46.0 | 44.0 | 37.5 |
| % Cellulose | 18.9 | 20.1 | 19.8 | 22.5 |
| % Lignin | 5.0 | 4.0 | 3.7 | 3.8 |

As is apparent from Table 2, both the crude protein mass and its percent of total dry mass increased during fermentation, while the masses and percents of total dry mass of both hemi-cellulose and lignin decreased. The mass of cellulose in the mixture, however, remained relatively constant. Since the total mass went down (generally because of the CO₂ given off), the relative percent of cellulose compared to the whole mixture increased.

### Example 3

### Fermentation with Bacillus amyloliquefaciens

Whole stillage was fermented in the presence of Bacillus amyloliquefaciens. The whole stillage (solids content of 30% by weight) was a feed co-product of ethanol production from corn. B. amyloliquefaciens was obtained as a wild strain and collected from a corn field near Manhattan, Kans. The B. amyloliquefaciens was further cultured before fermentation in liquid broth.

For fermentation, whole stillage (100 g) and B. amyloliquefaciens were combined in an Erlenmeyer shaker flask (250 mL). Ammonium sulfate (5.43 grams) was added as a nitrogen source, and dibasic potassium phosphate (0.4 gram) was added as a phosphorus source. Since B. Amyloliquefaciens is an aerobic bacteria, aeration was accomplished by stoppering the flasks with sterile cotton to allow for oxygen diffusion on the surface and using agitation with a temperature-controlled orbital shaker water bath (CellStar, Queue Systems Inc., Parkersburg, W. Va. The shaker bath rotates a tray which swirls the mixture. Will get mixer name and other info.

Fermentation occurred for three days. Samples were taken to measure the increase in crude protein and decrease in the fiber components. The results of the fermentation are shown in Table 3.

TABLE 3
Fermentation in the Presence of B. amyloliquefaciens

| | Control, Day 0 | Day 1 | Day 2 | Day 3 |
|---|---|---|---|---|
| Dry Matter weight | 21.6 | 19.2 | 18.9 | 20.2 |
| (grams) | | | | |
| Crude Protein | 5.4 | 9.9 | 3.9 | 3.9 |
| weight (grams) | | | | |
| Hemi-cellulose | 9.2 | 6.0 | 6.0 | 6.4 |
| weight | | | | |
| (grams) | | | | |
| Cellulose weight | 4.1 | 3.1 | 2.4 | 2.7 |
| (grams) | | | | |
| Lignin weight | 1.1 | 0.9 | 0.6 | 1.4 |
| (grams) | | | | |
| % Crude Protein | 25.2 | 51.8 | 20.6 | 19.5 |
| % Hemi-cellulose | 42.7 | 31.4 | 31.7 | 31.5 |
| % Cellulose | 18.9 | 16.2 | 12.9 | 13.6 |
| % Lignin | 5.0 | 4.7 | 3.4 | 6.9 |

While the crude protein content in the fermentation mixture increased after one day of fermentation, the protein content decreased after days 2 and 3. In this example, nutrients were not added during the course of the fermentation. Without being bound to a particular theory, it is believed that the cellulolytic micro-organisms were starved of nutrition, started to lyse, and began to feed on protein, thereby reducing the total protein content in the fermentation mixture.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description shall be interpreted as illustrative and not in a limiting sense.

1. A process for improving the nutritional quality of a feed co-product, resulting from the fermentation of a grain, sugar beets, or sugar cane to produce ethanol, the process comprising:
combining water, a source of nitrogen, a source of phosphorus, a feed co-product comprising a cellulose and/or a hemi-cellulose, and a microbe to form a fluid fermentation mixture suitable for submerged fermentation, wherein the feed co-product is derived from the fermentation of a grain, sugar beet, or sugar cane to produce ethanol and wherein the microbe is a microbe capable of breaking down the cellulose and/or the hemi-cellulose to one or more sugars and then utilizing the sugars to proliferate;
fermenting the fluid fermentation mixture such that the microbe converts at least a portion of the cellulose and/or the hemi-cellulose to at least one sugar and uses the sugar to proliferate thereby increasing the concentration of microbes in the fermentation mixture.

2. The process as set forth in claim 1 wherein the concentration of water in said fluid fermentation mixture is at least about 65 percent by weight.

3. The process as set forth in claim 2 wherein the concentration of water in said fluid fermentation mixture is from about 65% by weight to about 95% by weight.

4. The process as set forth in claim 2 wherein the concentration of water in said fluid fermentation mixture is from about 68% by weight to about 90% by weight.

5. The process as set forth in claim 2 wherein the concentration of water in said fluid fermentation mixture is from about 70% by weight to about 80% by weight.

6. The process as set forth in claim 1 wherein the cellulose and/or hemi-cellulose is derived from a cereal grain selected from the group consisting of corn, milo, wheat, barley, oats, triticale, rice, millet, rye, buckwheat and combinations thereof.

7. The process as set forth in claim 6 wherein the cellulose and/or hemi-cellulose is derived from corn.

8. The process as set forth in claim 1 wherein the cellulose and/or hemi-cellulose is derived from sugar beets.

9. The process as set forth in claim 1 wherein the cellulose and/or hemi-cellulose is derived from sugar cane.

10. The process as set forth in claim 1 wherein the microbe produces one or more cellulase or hemi-cellulase enzymes or cellulosome complexes of enzymes.

11. The process as set forth in claim 1 wherein the microbe is thermophilic.

12. The process as set forth in claim 1 wherein the microbe is mesophilic.

13. The process as set forth in claim 1 wherein the microbe is selected from the group consisting of an aerobic bacteria, anaerobic bacteria, yeast, fungus and combinations thereof.

14. The process as set forth in claim 13 wherein the microbe comprises an anaerobic bacteria.

15. The process as set forth in claim 14 wherein the microbe comprises an anaerobic bacteria selected from the group consisting of Clostridium, Ruminococcus, Caldicellulosiruptor, Erwinia, Bacteroide, Lachnospira, Butyrivibrio, Peptostreptococcus, and combinations thereof.

16. The process of claim 13 wherein the process further comprises introducing oxygen into the fermentation mixture.

17. The process as set forth in claim 16 further comprising controlling the oxygen content of the mixture within a range from about 10 mg/L to about 80 mg/L during fermentation of the fluid fermentation mixture.

18. The process as set forth in claim 16 further comprising controlling the oxygen content of the mixture within a range from about 10 mg/L to about 40 mg/L during fermentation of the fluid fermentation mixture.

19. The process as set forth in claim 16 further comprising controlling the oxygen content of the mixture within a range from about 10 mg/L to about 60 mg/L during fermentation of the fluid fermentation mixture.

20. The process as set forth in claim 16 wherein the microbe comprises an aerobic bacteria.

21. The process as set forth in claim 20 wherein the aerobic bacteria is selected from the group consisting of Cellulomonas, Bacillus, Thermobifida, Thermoactinomyces, Cytophaga and Sporocytophaga and combinations thereof.

22. The process as set forth in claim 13 wherein the microbe comprises a yeast.

23. The process as set forth in claim 22 wherein the yeast is selected from the group consisting of Candida, Zumononas, Saccharomyces Pachysolen, Yamadazyma, and combinations thereof.

24. The process as set forth in claim 13 wherein the microbe comprises a Fungus.

25. The process as set forth in claim 24 wherein the Fungus comprises selected from the phyla Chytridomycetes, Ascomycetes, Basidiomycetes, Deuteromycetes, and combinations thereof.

26. The process as set forth in claim 25 wherein the Fungus comprises a Chytridomycetes selected from the group consisting of Neocallimastix, Piromonas, Piromyces, Caecomyces, Oripmomyces, Anaeromyces, and combinations thereof.

27. The process as set forth in claim 25 wherein the Fungus comprises an Ascomycetes selected from the group consisting of Aspergillus, Trichoderma, Penicillum, Fusarium, Geotrichum, Bulgaria, Chaetomium, Paecilomyces, Helotium, Humicola, Sclerotinia, Myceliopthora, and combinations thereof.

28. The process as set forth in claim 25 wherein the Fungus comprises a Basidiomycetes selected from the group consisting of Coriolus, Phanerochaete, Poria, Postia, Schizophyllum, Serpula, Gloeophyllum, and combinations thereof.

29. The process as set forth in claim 25 wherein the Fungus comprises a Deuteromycetes selected from the group consisting of Cladosporium, Myrothecium, and combinations thereof.

30. The process as set forth in claim 1 further comprising controlling the pH of the mixture within a range from about 2.5 to about 10 during fermentation of the fluid fermentation mixture.

31. The process as set forth in claim 1 further comprising controlling the pH of the mixture within a range from about 6 to about 8 during fermentation of the fluid fermentation mixture.

32. The process as set forth in claim 1 further comprising controlling the pH of the mixture within a range from about 4 to about 9 during fermentation of the fluid fermentation mixture.

33. The process as set forth in claim 1 further comprising controlling the temperature of the mixture to be at least about 20° C. during fermentation of the fluid fermentation mixture.

34. The process as set forth in claim 1 further comprising controlling the temperature of the mixture within a range from about 20° C. to about 55° C. during fermentation of the fluid fermentation mixture.

35. The process as set forth in claim 1 further comprising controlling the temperature of the mixture within a range from about 25° C. to about 50° C. during fermentation of the fluid fermentation mixture.

36. The process as set forth in claim 1 further comprising controlling the temperature of the mixture within a range from about 30° C. to about 40° C. during fermentation of the fluid fermentation mixture.

37. The process as set forth in claim 1 further comprising controlling the nitrogen content of the mixture within a range from about 1% to about 10% by weight.

38. The process as set forth in claim 1 further comprising controlling the nitrogen content of the mixture within a range from about 2% to about 7% by weight.

39. The process as set forth in claim 1 further comprising controlling the nitrogen content of the mixture within a range from about 2% to about 8% by weight.

40. The process as set forth in claim 1 further comprising controlling the phosphorus content of the mixture within a range from about 0.05% to about 2% by weight.

41. The process as set forth in claim 1 further comprising controlling the phosphorus content of the mixture within a range from about 0.3% to 0.8% by weight.

42. The process as set forth in claim 1 further comprising controlling the phosphorus content of the mixture within a range from about 0.01% to 1% by weight.

43. A process for producing a high protein feed mixture from a cereal grain, the process comprising:
combining water, an enzyme and a cereal grain comprising a carbohydrate to form a hydrolysis mixture wherein at least a portion of the carbohydrate is converted by enzymatic hydrolysis into one or more sugars to form a hydrolysate mixture;
adding yeast to the hydrolysate mixture such that at least a portion of the sugar is converted by fermentation to ethanol to form a first fermentation mixture comprising ethanol, a cellulose and/or hemi-cellulose and water;
distilling the first fermentation mixture to remove at least a portion of the ethanol from the first fermentation mixture thereby forming a distillate product comprising ethanol and a whole stillage fluid mixture comprising water, a cellulose and/or hemi-cellulose;
adding a source of nitrogen, a source of phosphorus and a microbe to the whole stillage mixture to form a second fermentation mixture, wherein the microbe is a microbe capable of breaking down cellulose and/or hemi-cellulose to one or more sugars and then utilizing the sugars to proliferate; and
fermenting the second fluid fermentation mixture during which the microbe breaks down at least a portion of the cellulose and/or hemi-cellulose in the second fermentation mixture to at least one sugar and uses the sugar to proliferate to form a high protein feed mixture, wherein a substantial portion of the protein in the high protein feed mixture is microbial protein.

44.-85. (canceled)

86. A feed mixture resulting from the fermentation of a grain, sugar beets or sugar cane to produce ethanol, the feed mixture comprising:
a protein, at least a portion of which is in the form of a microbial protein, wherein the total concentration of protein present in the feed mixture is at least about 30 percent by weight of the feed mixture on a dry basis, and wherein the concentration of microbial protein in the feed mixture is at least about 10 percent by weight of the feed mixture, on a dry basis.

87.-102. (canceled)

103. A feed product comprising grain carbohydrate, grain ash, grain oil, a nitrogen source selected from the group consisting of grain protein and amino acids, and a further nitrogen source comprising microbial protein, wherein the total protein content is at least about 30 wt. % on a dry basis.

104.-105. (canceled)
